(19) United States
(12) Patent Application Publication
(10) Pub. No.: US 2013/0144451 A1
(43) Pub. Date: Jun. 6, 2013

(54) RESIDENTIAL AND COMMERCIAL ENERGY MANAGEMENT SYSTEM

(71) Applicant: San Diego State University Research Foundation, San Diego, CA (US)

(72) Inventors: Sunil KUMAR, San Diego, CA (US); Gordon Kui Fong LEE, Lakeside, CA (US); Yusuf OZTURK, San Diego, CA (US)

(73) Assignee: SAN DIEGO STATE UNIVERSITY RESEARCH FOUNDATION, San Diego, CA (US)

(21) Appl. No.: 13/660,876

(22) Filed: Oct. 25, 2012

Related U.S. Application Data
(60) Provisional application No. 61/551,042, filed on Oct. 25, 2011.

(51) Int. Cl. G05B 13/02

(52) U.S. Cl. CPC G05B 13/02
USPC 700/291

(57) ABSTRACT

A method and system of managing a residential or commercial energy system is described. The method includes predicting power consumption of a building, scheduling one or more appliances sufficient to optimize a consumer's energy usage, collecting usage profiles and demand and re-calculating the predicting of power consumption of a building.

This application claims the benefit of Application No. 61/551,042, filed 25 Oct. 2012 in the United States and which application is incorporated herein by reference. A claim of priority to all, to the extent appropriate, is made.

### BACKGROUND

With the current world economic crisis and the responsibility of all citizens to “go green” comes the need to provide efficient means for improving energy consumption in buildings. For example, the demand for electricity is at its peak during the summer months in general and during hot summer days in particular. The increased use of electrical appliances and HVAC systems in residential or commercial buildings plays a considerable role in this demand. However, usage of these appliances, including HVAC, can be done in a more cost efficient manner through scheduling, avoiding peak demand periods, and reducing consumption when the residential or commercial building is vacated.

State-of-the-art building automation and control systems employ remotely and/or PC controlled intelligent distributed controllers for a variety of building services including HVAC, energy management functions including optimum start/stop, night purge, and maximum load demand, supervisory functions for lighting, sun-blind, heat and energy metering and many other applications. Adoption of the BACnet® standard communication protocol has made it practical to integrate commercial building control products and systems made by different manufacturers.

Existing residential or commercial energy management systems are primarily designed to improve the energy efficiency and comfort within single structures. They often do not take into account the utility data (such as load forecasts or real-time pricing) for scheduling of appliances in all the dwelling units simultaneously to manage demand response in a residential or commercial community. As a result, they may not achieve efficient usage of locally generated solar power, peak load shift and load reduction on the electricity grid. Thus, present energy management systems (EMS) are customer centric and more tuned to comfort level rather than demand response (DR). Demand response (DR) can be defined as change in electric usage by end-use customers from their normal consumption patterns in response to change in the price of electricity over time. Demand Response also refers to incentive payments designed to induce lower electricity use at times of high wholesale market prices. Time-of-use (TOU) power pricing has been shown to have a significant influence on ensuring a stable and optimal operation of a power system.

In an electricity grid, the electricity consumption and production must be balanced at any time. Any significant imbalance in electricity consumption and production could cause grid instability or voltage fluctuations. Demand response strategy coordinates the requirements and needs between the energy provider and the consumer. It encourages the consumer to reduce the demand; thereby reducing the peak-demand. The utility company provides incentives to the consumer for load shedding. The demand response strategy provides the best adaptation of energy production capability for consumer needs. The strategy reduces the critical power mismatch and thereby reduces the need for investment in constructing new plants. The approach also avoids the use of more expensive and/or less efficient plants. Energy management can be formulated as a scheduling problem where energy is considered as a resource shared by appliances, and periods of energy consumption are considered as tasks. Generally, these approaches collect consumption activities by scheduling all the tasks as soon as possible in order to reduce the total consumption while satisfying a maximum energy resource constraint.

Price-based demand response (DR) programs include time-of-use (TOU) rates and real-time pricing (RTP). TOU is a type of static pricing scheme and usually only reflects long-term electricity power systems costs. RTP is the ideal pricing scheme; but the full implementation of RTP is difficult, due to the technical limitation of the demand side. Choi et. al. suggests a theory and simulation results of real-time pricing of real and reactive powers that maximizes social benefit. Conejo et. al. present an optimization model to adjust the hourly load level of a given consumer in response to hourly electricity prices and maximizes the utility of the consumer, subject to several constraints such as minimum daily energy-consumption levels and limits on hourly load levels. A multi-objective optimization problem is proposed in where the objective is to minimize the peak load and difference between the peak and valley loads. The multi-objective optimization problem is transformed into a single objective optimization problem and is solved by a fuzzy membership method. Case studies revealed that, by implementing real-time pricing, a demand reduction of between 8 and 11 GW at times of peak demand and low-wind could be achieved in the UK, due to the price elasticity and load-shifting.

In order to implement the demand response program, several methods were discussed in the literature for scheduling the load. An adaptation of the static Resource Constraint Project Scheduling Problems (RCPSP) was presented to improve the management of electric heating systems. This approach is able to co-ordinate the electric heaters while satisfying a maximum power resource constrained. In another approach, the authors formulated an optimization model for load management in electrolytic process industries. The formulation utilizes mixed integer nonlinear programming (MINLP) technique for minimizing the electricity cost and reduces the peak demand. The mixed integer programming problem is solved using a branch and bound algorithm. The inventors in one approach discuss the price prediction problem and introduce a weighted average price prediction filter which is designed and evaluated on a weekly basis, using the actual hourly price and introduced a linear programming scheme for optimal load control of appliances. In one case study, the scheduler determines the operation schedule of distributed energy resources that maximize the net benefits of the end user. This work used a co-evolutionary version of particle swarm optimization to generate the schedules.

### BRIEF DESCRIPTION OF DRAWINGS

FIG. 1 shows a block flow diagram of a method of managing a residential or commercial energy system, according to one embodiment.

FIG. 2 shows a conceptual diagram of the proposed residential or commercial energy management system, according to one embodiment.

FIG. 3 shows a flow diagram of the proposed system, according to one embodiment.

FIG. 4 shows a proposed hardware implementation of the management system, according to one embodiment.

FIG. 5 shows a flow diagram of the proposed system, according to one embodiment.

FIG. 6 shows a hierarchical adaptive learning control architecture, according to one embodiment.

FIG. 7 shows a current design of the GUI-interface of the master controller, according to one embodiment.

FIG. 8 shows an adaptive neural fuzzy network inference system (ANFIS), according to one embodiment.

FIG. 9 shows a graphical representation of differential pricing, according to one embodiment.

FIG. 10 shows partitions in the entire duration used in the branch and bound algorithm, according to one embodiment.

FIG. 11 shows an appliance operating state during different interval, according to one embodiment.

FIG. 12 shows a typical power consumption of the must run appliances (lightly shaded region) and the power availability for the schedulable appliances, according to one embodiment.

FIG. 13 shows a typical demand curve, according to one embodiment.

FIG. 14 shows a power generation cost, according to one embodiment.

FIG. 15 shows a prediction result for residential or commercial appliance usage for (a) microwave oven, (b) television, (c) refrigerator and (d) air conditioner, according to one embodiment.

FIG. 16 shows a power availability and cost of electricity during different time for the example, according to one embodiment.

FIG. 17 shows results when using the scheduling algorithm, according to one embodiment.

FIG. 18 shows a power profile with the reference price, according to one embodiment.

FIG. 19 shows a solar power availability during different time of the day, according to one embodiment.

FIG. 20 shows price elasticities during different periods of the day, according to one embodiment.

FIG. 21 shows a power profile before and after demand response programs with the power generation limit given in Table 2 (dark shaded—before demand response, light shaded—after demand response), according to one embodiment.

FIG. 22 shows a power profile before and after demand response programs with the power generation limit given in Table 3 (dark shaded—before demand response, light shaded—after demand response), according to one embodiment.

FIG. 23 shows a power profile before and after demand response programs with the power generation limit given in Table 4 (dark shaded—before demand response, light shaded—after demand response), according to one embodiment.

FIG. 24 shows a typical electricity consumption patterns, according to one embodiment.

### DETAILED DESCRIPTION

One goal of the proposed system is to predict and tailor the electricity demand (e.g., peak load reduction and shift) in a locality at a given day/time, avoid blackouts, and reduce the utility bills for residential or commercial customers. This will be achieved by dynamically scheduling and controlling various residential or commercial appliances in the dwelling unit.

A residential or commercial consumer's daily activities can be characterized by a list of tasks to be scheduled at preferred time intervals. Some of these tasks are persistent, as they consume electricity throughout the day (e.g. A/C, refrigerator, etc.), while others are more flexible within a defined time interval (e.g. washer/dryer, oven, etc.). The demand-side energy management problem is considered as the scheduling of a consumer's daily tasks according to user-specified deadlines and the time of use pricing of the market, while achieving cost saving and peak reduction. A branch and bound algorithm is formulated that schedules the appliances as per the consumer's usage preference. One embodiment also presents an algorithm for finding optimum time-of-use electricity pricing in monopoly utility markets; definitions and the relations between supply and demand as well as different cost components are also presented. Further, the optimal pricing strategy is developed to maximize the benefit of society while implementing a demand response strategy.

A cognitive system for management of residential or commercial power loads for optimization of the cost for the customer and smoothing the energy demand for the utility company is developed. The system developed has several integrated components enabling prediction of energy demand based on historical demand, renewable energy sources available, and other relevant data that impacts an energy user's life style (such as weekend versus weekday, holidays, vacations etc.). The demand predicted per residential or commercial building by the cognitive adaptive neuro-fuzzy estimation function of the system is communicated to a demand aggregator. The demand aggregator is a generalized predictor which utilizes the demand submitted from residential or commercial cognitive energy manager to predict the near term and far term energy demand in a locality. The near term demand prediction is aimed to be used for TOU (Time of use pricing) and cost incentives to the customer, while the far prediction is aimed at capacity planning by the utility.

A scheduler is developed to make use of TOU pricing and incentives offered by the utility company, and schedule power loads in the residential or commercial building at optimal times for the residential or commercial user without constraining the user's lifestyle. The system takes into account the time of use pricing information provided by the utility, the renewable energy sources available, the constraints provided by the user and schedules appliances to make use of TOU pricing by optimizing the run time schedules of appliances or power loads.

Another embodiment describes a residential or commercial energy management software system which runs on a variety of platforms providing the user an easy to use graphical user interface for managing power loads and scheduling appliances for future runs. The residential or commercial energy management software is composed of such components as a graphical user interface, a scheduler for making use of TOU pricing, a cognitive power demand predictor and a residential or commercial area network gateway to communicate with appliances in the residential or commercial building.

A self-organizing self-discovery self-healing ad-hoc network is developed for smart appliances. The network nodes are smart appliances requiring zero configuration by the user for the registration, authentication, status report and control of appliances in the residential or commercial building.

A closed loop complete solution has been developed for monitoring, predicting and optimizing energy consumption at the residential or commercial building based on Time-of-Use pricing data, user's preferences and other foreseeable factors. The closed loop integrated solution is composed of a residential or commercial master-controller, a set of appliance network nodes forming a self organizing network, an aggregator accumulating demand in a region for time of use pricing and finally a cognitive scheduler managing appliance at the residential or commercial building, based on the user's preferences and energy schedules offered. The residential or commercial master-controller provides a user friendly interface for interacting with the energy management devices in addition to gathering usage patterns from the user for estimation of future demand. The master-controller, in addition, runs the cognitive demand predictor and the cognitive scheduler for estimation of the demand and management of allocated energy. The self organizing appliance nodes are drop-in modules which will enable management of legacy applications as well as smart appliances.

There are multiple embodiments discussed herein. A neuro-fuzzy predictor is discussed for estimating the power consumption at the residential or commercial building, based on the user's choices in the past. The predictor takes as input the recent usage information for an appliance, the calendar information, temperature and other environmental factors that may impact the use of a particular appliance and finally the energy supply from renewable energy sources in the residential or commercial building. The predictor will return the probability of an appliance to be activated (powered) in a particular time frame in the near future. The solution we developed is a closed loop one where the response to the energy demand from the utility company by the customer is translated into economic incentives in the form of time of use pricing or peak value pricing to smooth the demand via behavior modification. The Neuro-Fuzzy predictor is also aimed to estimate the impact of the incentives on a user's decision to consume energy for a particular task at a particular time. The cognitive neuro-fuzzy controller performs the prediction of appliance usage patterns in the residential or commercial building and uses this as confidential information by providing anonymous power usage data to the aggregator. This feature resolves the concern of consumer confidentiality.

A residential or commercial energy manager is described, denoted as the master-controller, to cognitively schedule appliances to optimize the user's benefit, based on preferences and time of use pricing information from the utility company. The master controller offers a GUI to the user for controlling the appliances at the residential or commercial building while capturing the user's preferences to be used for prediction purposes. The graphical user interface enables the user to be informed and to be in charge of the energy consumption at the residential or commercial building in addition to serve as a user behavior data collector for use in the cognitive predictor.

A self organizing, self healing residential or commercial area network is described for smart energy management in the residential or commercial. The network uses a cluster tree topology enabling both scalability and reliability. This zero configuration network enables the appliances to be part of the smart energy management network with no user configuration. A regional energy manager (Aggregator) is described which harvests usage profiles and the demand for energy in the future from master controllers. The proposed system will provide continuous interaction between the residential or commercial customer and the utility company by employing an adaptive neural-fuzzy learning algorithm.

The utility company will be given the ability to predict and tailor the electricity demand in multiple dwelling units simultaneously in a given residential or commercial community: (i) by providing suitable incentives (such as differential pricing) to customers, and (ii) by scheduling and controlling appliance operation. This will help in DR by reducing and shifting the peak load, better forecast of electricity demand and thus avoid load shedding during peak seasons.

Customers will be assisted in making decisions in feeding the excess solar power to the electricity grid through the ‘net metering’ scheme. This will help in DR by reducing the load on the grid during the peak load conditions. This will also reduce the need for the utility to buy electricity at higher rates during peak load conditions.

The system described herein provides an inexpensive, user-friendly, and easy to install/maintain architecture for both customer and utility provider. There are be several advantages to the residential or commercial customer in using the proposed system: (a) Improved energy efficiency for electricity and gas usage, thus resulting in greater cost savings; (b) Maximize the use of solar power locally within the residential or commercial building; (c) Maximize user comfort by learning from user inputs, usage patterns and weather conditions; (d) Effective customer education and interaction—information to the customer about the daily, weekly and monthly energy consumption patterns and provide advice on energy savings to meet customer's monthly energy budget.

The system would be seamlessly configured and reconfigured at the customer end to control various residential or commercial appliances, lighting, HVAC system and water heater, either remotely or locally on the Master Controller.

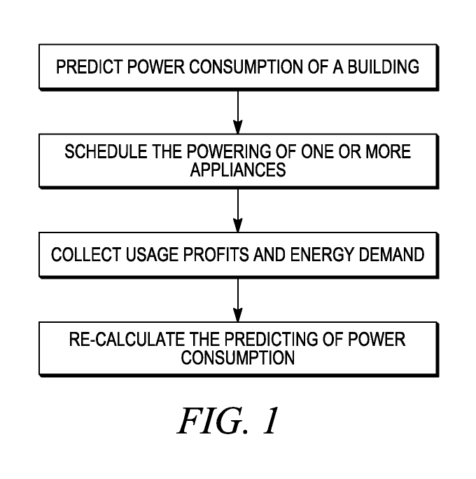

Referring to FIG. 1, a block flow diagram of a method of managing a residential or commercial energy system is shown, according to some embodiments. The power consumption of a building is predicted. One or more appliances are then scheduled for powering, sufficient to optimize a consumer's energy usage. Usage profiles and demand are collected and the predicting of power consumption of a building is re-calculated. The steps may then be repeated.

The proposed system addresses the Demand Response (DR) from both the utility as well as customer end. The energy management system learns and adapts to the residential or commercial energy usage patterns and demand. At both levels, the learning algorithm will take DR decisions based on the following factors: (1) peak load forecast, (2) differential electricity prices, (3) customer's usage patterns and energy budget, and (4) available solar power.

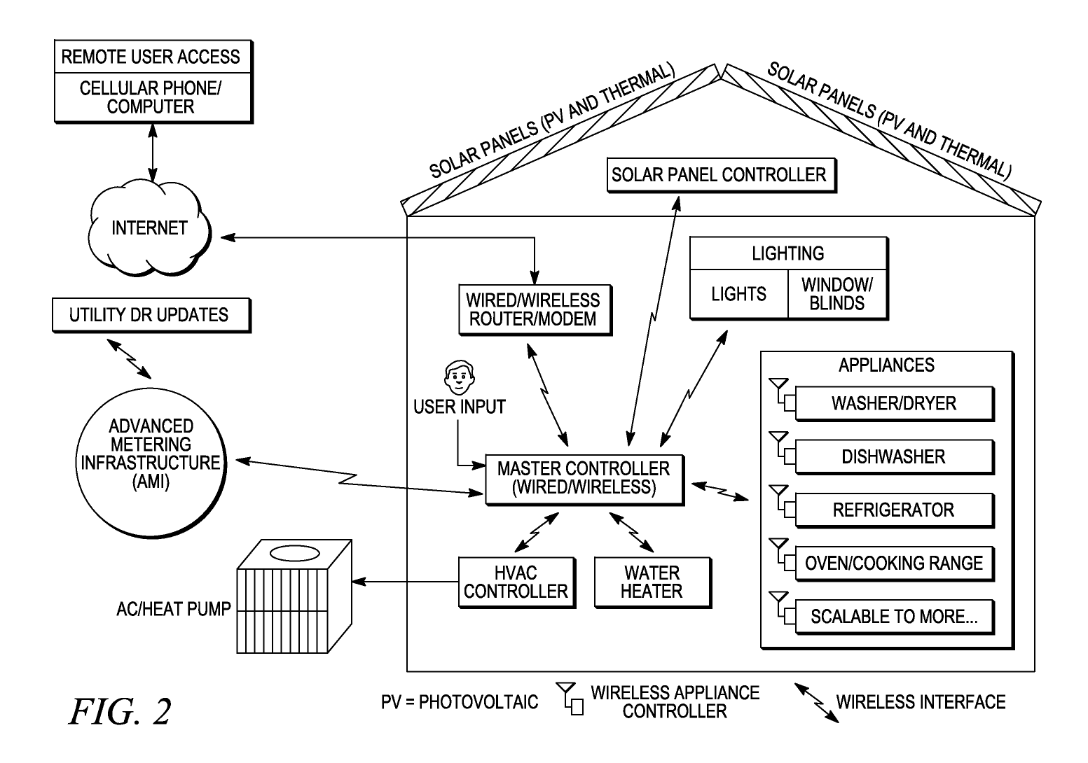

The conceptual diagram of the proposed system is shown in FIG. 2. The system will consist of a reconfigurable master controller (MC), appliance and solar unit control emulators with wired/wireless communication interface (e.g., Internet, ZigBee). The system will be seamlessly controlled by the utility (via AMI) as well as customers either remotely (via Internet, wireless LAN, and/or cellular network) or locally on the MC. The communication between the customer and the utility will take place wirelessly via AMI infrastructure. The MC will configure, control and schedule the operation of all the residential or commercial appliances through individual, inexpensive wireless appliance controllers. The system will be scalable to different types of dwelling units, cost-effective, user-friendly, and easy to install/maintain.

The MC is a cognitive and intelligent unit capable of scheduling the operation of all the residential or commercial appliances and HVAC based on the user and utility inputs to meet DR objectives. For example, when a user schedules the operation of the washer/dryer, the MC may determine that a two hour delay in starting the appliance would result in cost savings. This message along with the actual savings will be available to the user on the appliance panel or MC panel. The user can either accept this advisory or opt for immediate operation.

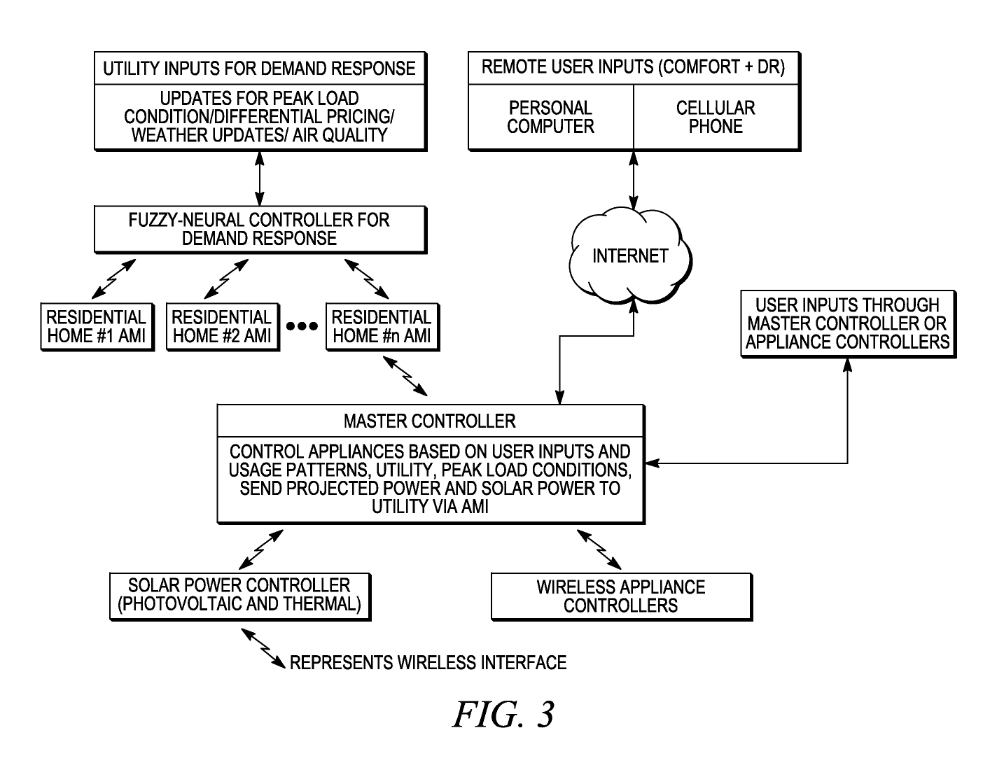

As shown in FIG. 3, the communication and interaction between different components of the proposed system can take place in 3 stages: (i) appliance/solar controllers and MC, (ii) user and MC, (iii) MC and utility via AMI. The inputs to the system would come from both the residential or commercial customer as well as the utility as discussed below. The user accesses the system inside the residential or commercial building through the MC (via key pad) or Appliance Controller(s), or remotely through Internet connection from PC or cellular phone.

The user inputs (via MC) will comprise of appliance(s) operation settings and schedules, appliance make, model and power ratings, usage patterns, dwelling unit type and size, installed solar PV and thermal power generation capacity, and target monthly energy budget (presumably depending on household income). The customer's usage patterns would take into account the history of energy demand considering the following parameters: (i) time and season (time-of-day, day-of-week, month-of-year effects), and (ii) weather including the effects of persistent extreme weather. For example, the thermal loads can increase on subsequent days of a cold spell.

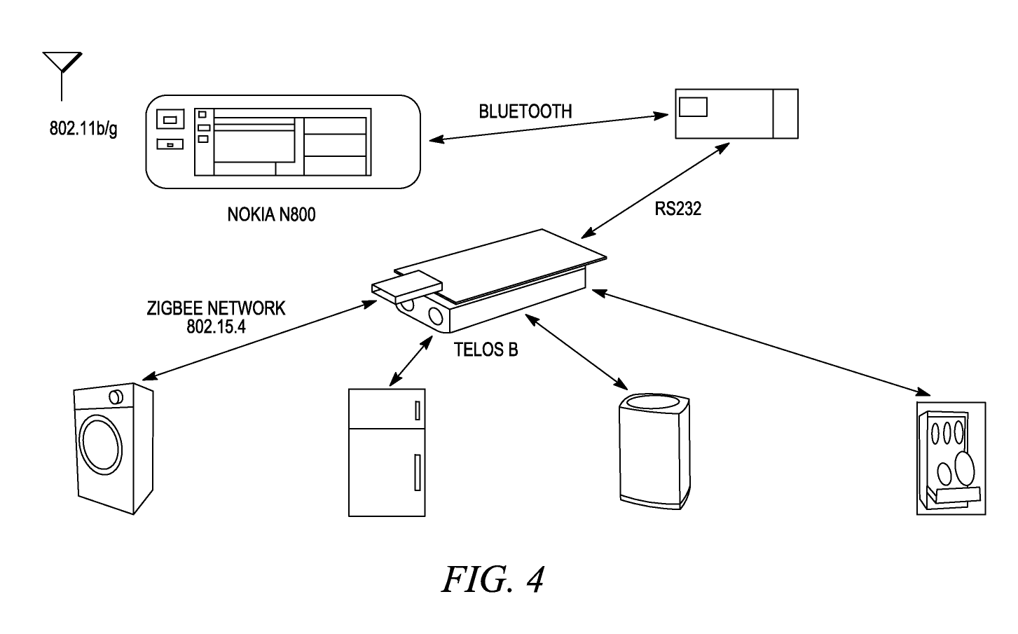

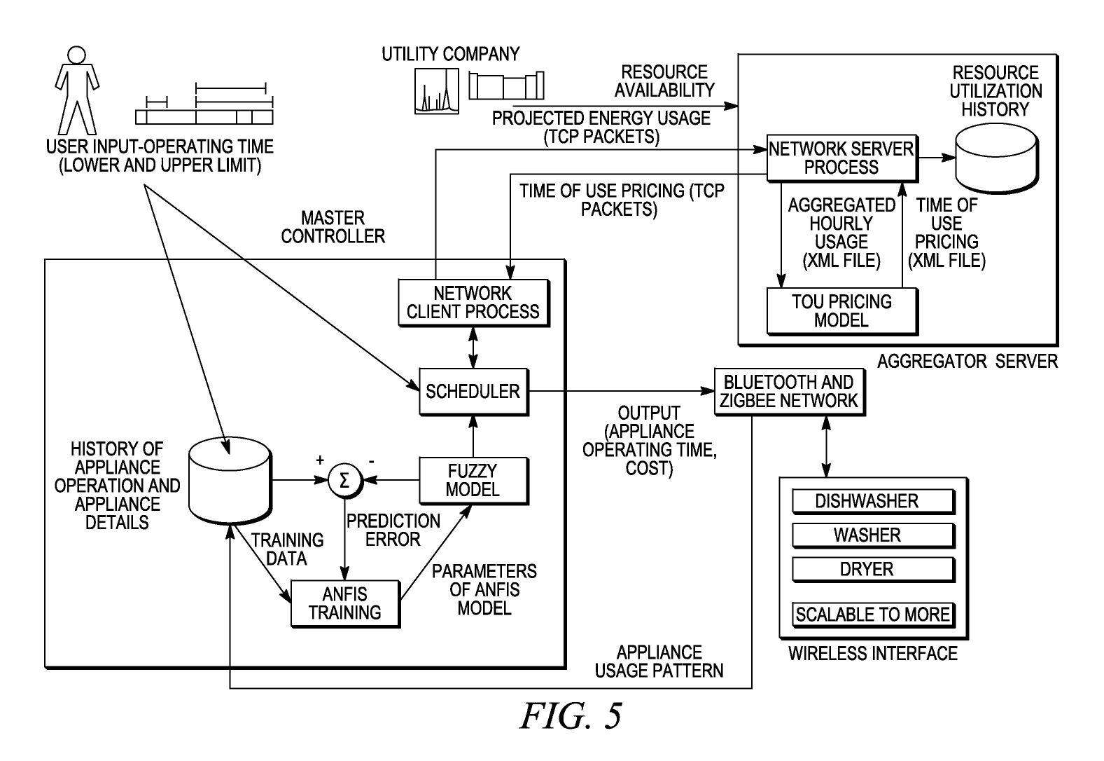

The current implementation design of the network is shown in FIG. 4. As shown in FIG. 5, the communication and interaction between different components of the proposed system can take place in 3 stages: (i) appliance/solar controllers and MC, (ii) user and MC, (iii) MC and utility via AMI. The inputs to the system would come from both the residential or commercial customer as well as the utility as discussed below.

The user accesses the system inside the residential or commercial building though the MC (via key pad) or Appliance Controller(s), or remotely through Internet connection from PC or cellular phone. The user inputs (via MC) will comprise of appliance(s) operation settings and schedules, appliance make, model and power ratings, usage patterns, dwelling unit type and size, installed solar PV and thermal power generation capacity, and target monthly energy budget (presumably depending on household income). The customer's usage patterns would take into account the history of energy demand considering the following parameters: (i) time and season (time-of-day, day-of-week, month-of-year effects), and (ii) weather including the effects of persistent extreme weather. For example, the thermal loads can increase on subsequent days of cold spell.

Boucher and others developed a modular adaptive scheduling approach for minimum energy usage. The authors formulated a supply heat index performance metric and, using the principle of thermodynamics and the impact of actuators on the energy system, a simple control strategy is developed and tested on a raised floor data center. While the results look promising, the approach uses very specific sensor data, actuator models and environmental conditions in the study.

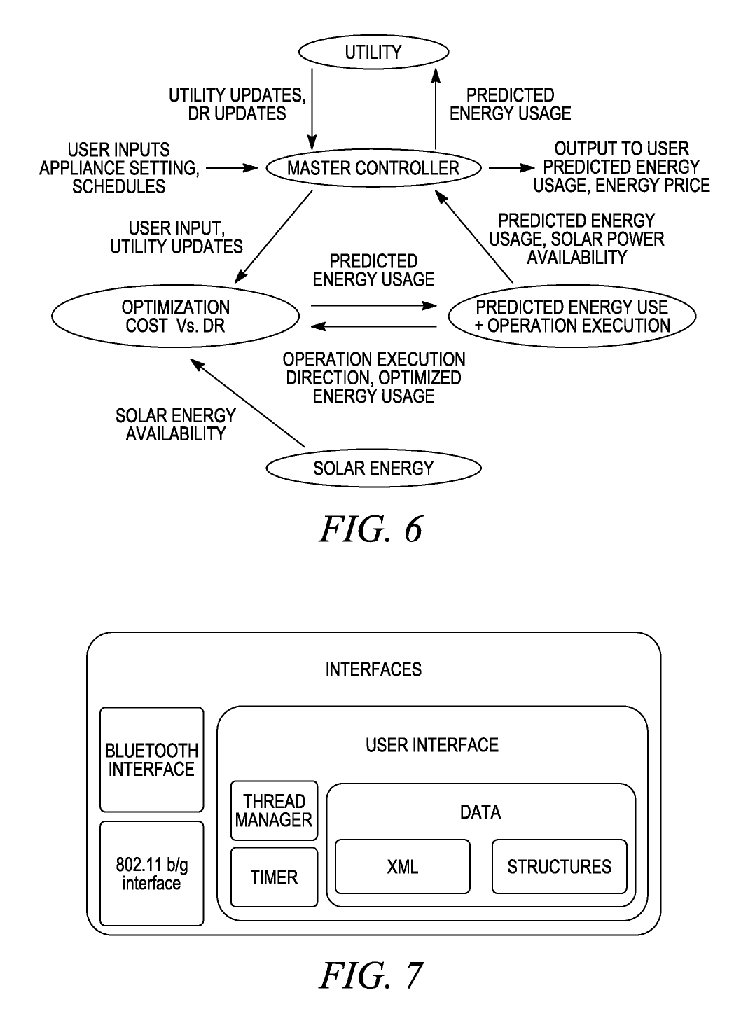

As energy management is a complex task, the dynamics of the system of systems are nonlinear, the compensation is naturally decentralized and the environment and user demands are changing with time and season. In this effort, we plan to employ non-parametric techniques. First we note that learning must integrate the customer's needs, the utility provider's requirements and constraints and the machines capabilities (sensors and actuators with delays and limitations). FIG. 6 illustrates the synergy of this interaction. FIG. 7 shows an example of a GUI.

At the local level, each customer's master controller (MC) uses a simple adaptive neural fuzzy inference system (ANFIS) as explained below. The inputs to the MC include user preferences (appliance settings and schedules) and the outputs include the predicted energy usage which updates the utility DR data. The MC in a given residential or commercial building will compute the predicted energy demand for a given time slot by using the above-mentioned user and utility parameters. For this purpose, the utility may divide the 24 hour duration in one hour time slots. Each MC will communicate to the utility (via AMI) the predicted energy demand in a residential or commercial building for the given time slot. This data will be aggregated at the substation from all the residential or commercial buildings being served by it. The system at the utility end will thus periodically (or continuously) collect the predicted energy demand data in a given residential or commercial community.

At the global level resides the utility provider. The utility provider has boundary conditions like cost constraints, power availability, government regulations etc. Inputs to the utility controller include the power availability on the grid, predicted solar power generation, and the predicted energy usage in the residential or commercial community, together with other energy demand data (e.g., industrial and commercial energy demand), and weather. Outputs include the DR data to the customers (e.g., cost incentives and differential pricing).

The utility would already have a database of the types of residential or commercial buildings and the customers' likely response to the change in electricity price. The change in the price of electricity will enable the utility to further tailor the energy demand by encouraging the customers' master controllers for rescheduling the appliance operations

It is noted that the user influences the optimization and scheduling decisions for cost versus comfort level versus demand response. Given the feedback from the customer into the master controller, the local controller can also add passive suggestions to customer. Thus, the customer at the local level can have a say as to the level of optimization he/she receives under the local constraints and global boundary conditions.

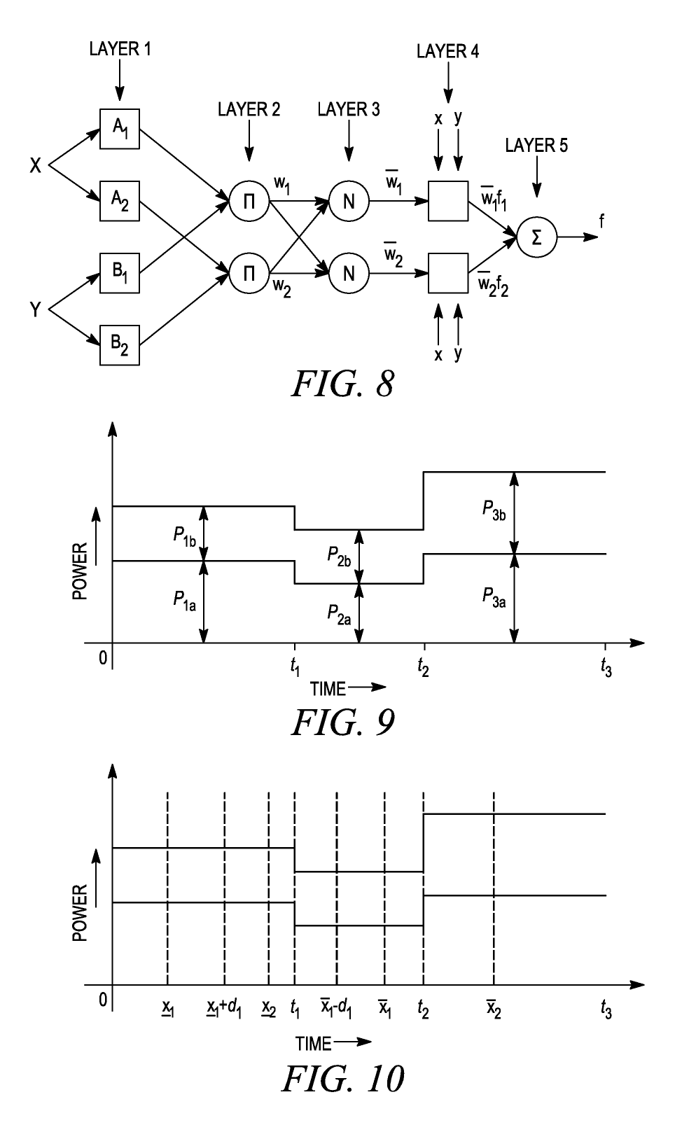

The heart of the learning is the adaptive fuzzy neural network inference system (ANFIS). The ANFIS has two parts: (i) the neural network provides the learning mechanism to identify the unknown or changing plant, (ii) the fuzzification component compensates the uncertainties or inaccuracies of the plant as well as of the environment. As shown in FIG. 8, the first layer takes various customer and utility inputs and fuzzifies the data. Layer 2 weights the different inputs according to some priority while layer 3 normalizes the resulting weighted data (layer 2 and 3 are the neural network component). In layer 4, the inputs are evaluated according to some rules and, in layer 5, the rules are combined to produce a numeric action, the output.

Two sets of parameters need to be tuned, the premise parameters (in layer 1) and the consequence parameters in layer 4). The ANFIS is used in the master controller in order to predict a residential or commercial customer's typical energy usage. The identification of fuzzy models for prediction of appliance usage is a quite complex task. For a system with large number of input variables, it is necessary to carefully select the input variables that are relevant to the output. As the system is not well know, group method for data handling with the regularity criterion (RC) is used to find the significant input. The identification data must be divided into two groups and the RC is defined as:

$$RC = [ {\sum }_{i = 1}^{{k}_{A}} \frac{{( {y}_{i}^{A} - {y}_{i}^{AB} )}^{2}}{{k}_{A}} + {\sum }_{i = 1}^{{k}_{B}} \frac{( {y}_{i}^{B} - {y}_{i}^{BA}}{{k}_{B}} ] / 2 \qquad ( 1 )$$

where k_{A} and k_{B} are the number of data of group A and B respectively, yᵢ^{A} and yᵢ^{B} are the output data of group A and B, y^{AB} is the model output for group A input estimated by the model identified using group B data and y^{BA} is the model output for group B input estimated by the model identified using group A data. Let us consider the system with n inputs. The identification is carried out as follows:

The input-output data set is divided into two groups A and B.

Using the two groups of data, A and B two fuzzy models Mⁿ_{A} and Mⁿ_{B} respectively are built for each group, starting with only one input and 2 membership function. At this stage, a fuzzy model is built for each input in consideration.

After training, the reference networks Mⁿ_{A} and Mⁿ_{B} are tested using data sets B and A. respectively. Compute the RC using the relation in (1).

The input with the minimum RC is considered as important variable and that particular input is fixed with that number of membership function.

In the next stage, consider all the input variables i=l, . . . , n, if the input variable i is already fixed increment the number of membership functions and if the input variable i is not fixed include it, one at a time. In this stage, a fuzzy model is built for change in each input variable and the RC is calculated. The same process is repeated until the minimum value of RC increases.

Typically, residential or commercial consumers may be charged some average price for electricity, irrespective of the time of use. But wholesale pricing of electricity may vary from time to time between the low demand period (e.g. night time) and high demand period (e.g., afternoons). This magnifies the need for differential pricing that provides financial incentives to consumers for shifting their demand from peak to off-peak periods. This pricing links the production and the electricity demand and gives incentives to reduce the demand when the supply of power is limited.

A graphical representation of differential pricing is shown in FIG. 9. Electricity is charged at different rates during different times of the day for different power levels and it is determined using estimated future demands. Because of differential pricing, an efficient energy management schedule should be constructed that satisfies demand response while providing reduced costs to the residential or commercial consumer. In order to implement the demand response program, based upon the ANFIS consumer profile to predict future energy usage, an appliance scheduling plan can be generated.

The branch-and-bound technique is a global optimization technique used for non-convex optimization problems. This method typically relies on a priori knowledge about the problem. The basic concept underlying the branch-and-bound technique is divide and conquer. The original “large” problem is divided into smaller and smaller sub-problems until these sub-problems can be conquered (solved). The approach estimates upper and lower bounds (UB, LB) of the original problem and discards the subset if the bound indicates that it cannot contain an optimal solution. After the problem is divided into a set of smaller sub-problems, the algorithm is applied recursively to the sub-problems. The search proceeds until all nodes (sub-problems) have been solved or pruned.

Assume there are n appliances that need to be scheduled. These appliances need to be scheduled between the time xᵢ and x̅ᵢ, (i=1, 2, . . . , n). Here xᵢ and x̅ᵢ represents the lower and upper limit of the appliance operating time. The available power at any time is P_{yz}, yε{1, 2, . . . , m}, zε{a, b, c, . . . } and the cost per kWh for the corresponding power during different operating times is c_{yz}. Here yε{1, 2, . . . , m} represents the different periods of the day viz., peak, off-peak and normal period and zε{a, b, c, . . . } represents the different power level. A typical cost-power profile for the differential pricing is shown in FIG. 10. The power consumed by the appliance is qᵢ (i=1, 2, . . . , n) and the appliance's operating duration is dᵢ (i=1, 2, . . . , n). The problem is to find the optimum value of the appliance switching-on time xᵢ (i=1, 2, . . . , n) such that the total electricity cost is minimum. Also the appliances need to be scheduled such that the power required by these appliances is less than the maximum power availability.

Consider a vector N=[0, t₁, . . . , tₘ, x₁, . . . , xₙ, x̅₁, . . . , x̅ₙ, x₁+d₁, . . . , xₙ+dₙ, x̅₁−d₁, . . . , x̅ₙ−dₙ] which represents a time interval in which an appliance is in operation. The elements of the vector N are sorted in ascending order and the entire duration is divided into a number of divisions using the elements of N. Consider a case with the divisions as shown in FIG. 8.

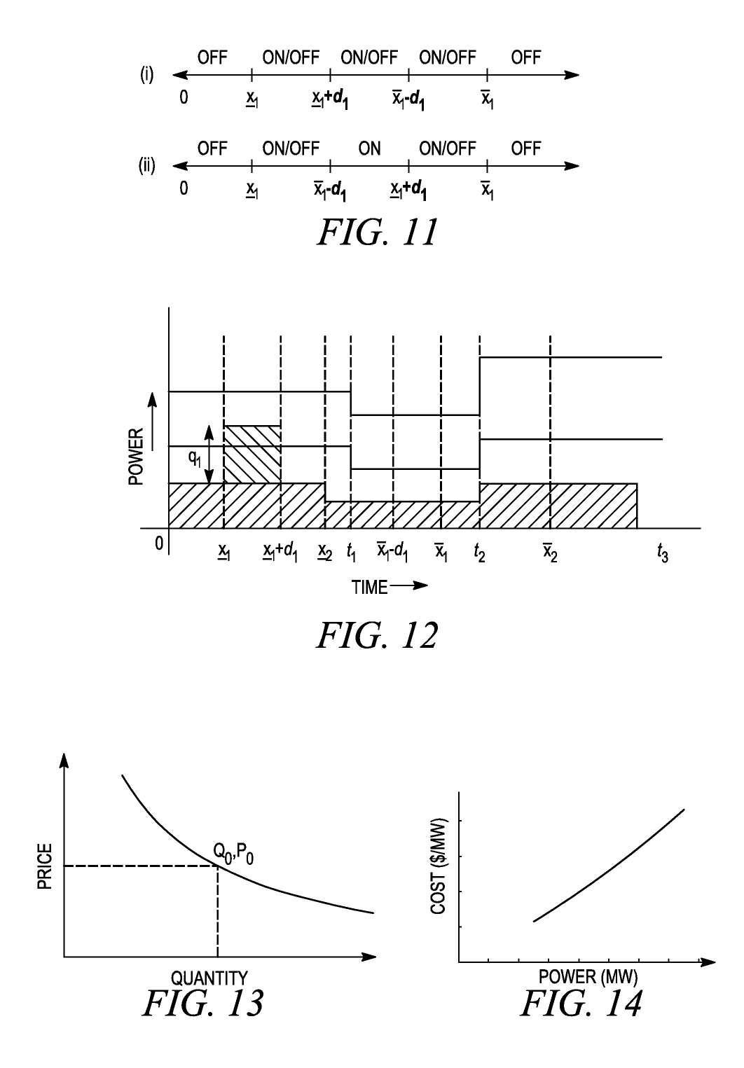

Consider an appliance, labeled appliance 1, which must operate between the time x₁ and x̅₁. In FIG. 10, the duration between x₁ and x̅₁ is divided as [x₁, x₁+d₁], [x₁+d₁, x₂], [x₂, t₁], [t₁, x̅₁−d₁] and [ x̅₁−d₁, x̅₁]. Between 0 and x₁, the appliance must be in the ‘OFF’ state. During the interval between x₁ and x₁+d₁, the appliance may be in either the ‘ON’ or ‘OFF’ state. Similarly during the interval [x₁+d₁, x₂], [x₂, t₁], [t₁, x̅₁−d₁] and [ x̅₁−d₁, x̅₁] the appliance state is ‘ON’ or ‘OFF’. Beyond the time after x̅₁, the appliance is in the ‘OFF’ state. Here x₁− x̅₁>d₁. The state of the appliances for this case is shown in FIG. 11 (i). For x₁− x̅₁<d₁, the state of the appliances is shown in FIG. 11 (ii).

If the appliance is ‘OFF’, then the lower and upper bounds of power is 0. For the appliance states, ‘ON/OFF’ and ‘ON’, the lower bounds are 0 and q₁, and the upper bound is q₁ for both the cases. The bounds of power for all the appliances are calculated in the same way. The bounds of the cost are calculated using the bounds of power for all the appliances and the cost per kWh in different intervals of time.

The available power for the schedulable appliances is calculated by subtracting the power consumed by the must run services from the total available power. If the lower bound of power is qᵢ for any appliance during some interval, then the appliance must be in the ‘ON’ state during that interval. Hence this power is also subtracted from the available power and the remaining power is the power available for the appliances that needs to be scheduled. The cost per kWh during the different intervals is then calculated using the available power and the charge for the different power level. In FIG. 12, typical power consumption by the must run services is shown by the lightly shaded region. The region above the lightly shaded region is available for the schedulable appliances. In FIG. 10, between the interval x₁ and x₁+d₁, the lower and upper power bounds for appliance 1 is 0 and q₁. This region is shown by a dark shaded region. Let w portion of power q₁ come under the power level, represented by P₁ₐ and the remaining portion (1-w) comes under the region P_{1b}. In this case, the cost per kWh for operation of the appliance between x₁ and x₁+d₁ is given by the wc₁ₐ+wc_{1b}. The cost per kWh for operation of appliances is calculated for all the appliances in all the intervals.

The operating duration of the appliance is dᵢ. In any interval, if the lower bound of power is qᵢ then the appliance is ‘ON’ in that interval. The remaining time of operation of the appliance is obtained by subtracting all such intervals from dᵢ. Now the remaining duration is distributed in the intervals where the lower and upper power bounds are 0 and qᵢ, starting from the interval where the cost per kWh for operation of the appliance is low. The sum of the operating cost of the appliance in all the intervals gives the lower bound of the operating cost of appliance i. The lower bound of the operating cost for all appliances is calculated by adding the lower bounds of the operating costs for all the appliances.

The upper bound of the operating cost is calculated in a similar way. The only difference is instead of distributing the appliance operating duration in the intervals with low cost per kWh, it is distributed in the intervals where the cost is maximum. While calculating the lower and upper bounds, the appliances are considered to operating with a discontinuity for each cycle. As the branching progresses and when the interval reduces, the discontinuity will reduce. When the interval is close to zero, the appliance operation will be continuous for each cycle of operation.

A branching rule is used to split the current problem being solved into sub-problems. The efficiency of the branch-and-bound algorithm depends on the branching rule and also on the bound calculation method.

The duration of operation of an appliance is di (i=1, . . . , n) and the bounds of the appliance switching ON time is x₁ and x̅−d₁. The branching operation is performed on the sub-problem, where the lower bound is minimum. Next the value of i needs to be found for the branching operation. The difference in the energy bounds will reduce if (( x̅ᵢ−dᵢ)−xᵢ)<qᵢ. Hence the subdivision is carried out on i_{M}, where i_{M} is given by

a. i_{M}=arg min{((xᵢ−dᵢ)qᵢ}, i=1, . . . N (2)

The lower and upper bounds of the new sub-problems are calculated and the branching operation is stopped when the minimum of the lower bound is closer to the upper bound.

An iterative linear programming is employed based optimization problem formulation resulting in a solution that maximizes the consumer surplus by adjusting the electricity price and guaranteeing a fixed profit to the utility company. This solution presented adjusts the electricity price and keeps the load peaks within the power system constraints.

FIG. 13 shows a generalized relationship between the price of a good and the quantity which consumers are willing to purchase, at a given price. This is known as a simple demand curve. Since many variables other than the price may influence the quantity demanded, it may be difficult to derive the relation between the price and the quantity. Economist often linearized this curve around a given point. Price elasticity of demand (PED) is a measure used in economics to show the responsiveness, or elasticity, of the quantity demanded of a good or service to a change in its price.

The PED measures how much consumers respond in their buying decisions to a change in price. The basic formula used to determine price elasticity is given as:

$$A . P E D ( \overline{ɛ} ) = \frac{\% change in quantity demand}{\% change in price} = \frac{Δ Q / {Q}_{0}}{Δ P / {P}_{0}} \qquad ( 3 )$$

where ΔQ and ΔP are respective changes in demand and price; and Q₀ and P₀ are base demand and price. If the price and quantity is normalized in a given equilibrium point (Q₀,P₀), the price elasticity of demand or the self elasticity can be expressed as [26]:

$$ɛ = \frac{Δ Q}{Δ P} \qquad ( 4 a )$$

In some cases, a change in the price of one commodity will affect the demand for another commodity. For example, an increase in the price of coffee will reduce the demand for coffee but may increase the demand for tea. Elasticity of substitution shows to what degree two goods or services can be substitutes for one another. If the price and quantity is normalized in a given equilibrium point, the substitution elasticity or cross elasticity between two products ‘a’ and ‘b’ can be expressed as:

$$a . {ɛ}_{ab} = \frac{Δ {Q}_{a}}{Δ {P}_{b}} and {ɛ}_{ba} = \frac{Δ {Q}_{b}}{Δ {P}_{a}} \qquad ( 4 b )$$

When the two goods are substitutes for each other, the cross elasticity of demand will be positive. The effect between the demands of product ‘a’ and the price of these two commodities is given by:

ΔQₐ^{s}=εₐₐΔPₐ; εₐₐ≦0 (5)

ΔQₐ^{c}=ε_{ab}ΔP_{b}; ε_{ab}≧0 (6)

where ΔQₐ^{s} and ΔQₐ^{c} represents the change in price of commodity due to self elasticity and cross elasticity respectively.

With respect to the demand for electricity, a self-elasticity coefficient relates the demand during an hour period to the price during the same period. A rescheduling of appliances implies that the consumer reduces its electricity demand during some peak period and increases it another during normal or off-peak periods. Cross-elasticity coefficients relate the demand in one hour to the price during other hours. The change in demand at an hour caused by a deviation of the published prices from the prices expected by the consumers is therefore given by the sum of individual effects. If the reciprocal effects between the two commodities are considered, then the effect between price and demand can be defined as:

$$( \begin{matrix}Δ {Q}_{a} \\ Δ {Q}_{b}\end{matrix} ) = ( \begin{matrix}{ɛ}_{aa} & {ɛ}_{ab} \\ {ɛ}_{ba} & {ɛ}_{bb}\end{matrix} ) ( \begin{matrix}Δ {P}_{a} \\ Δ {P}_{b}\end{matrix} ) \qquad ( 7 )$$

The diagonal elements of this matrix represent the self-elasticities and the off-diagonal elements correspond to the cross-elasticities. A column of this matrix indicates how a change in price during the single period affects the demand during all the periods. If the nonzero elements in this column are above the diagonal, the consumers react to a high price by shifting their consumption forward in time. If they are below the diagonal, they postpone their consumption until after the high price period. If consumers have the ability to reschedule their production over a long period, the nonzero elements will be spread widely over the column. On the other hand, if flexibility is limited, the nonzero elements will be clustered around the diagonal. Some customers may also decide that, if they have to reschedule their electricity consumption, they might as well take advantage of the hours of lowest prices, which typically are in the early hours of the morning. For m commodities, the effect between price and demand can be defined as:

$$i . Δ {Q}_{i} = {\sum }_{j = 1}^{m} {ɛ}_{ij} Δ {P}_{j} \qquad ( 8 )$$

Ramsey pricing or the Ramsey-Boiteux pricing principle is a linear pricing scheme designed for the multiproduct natural monopolist. It is a policy rule focusing on what price a monopolist should set, in order to maximize social welfare, subject to a constraint on profit. As per this pricing rule, the consumer surplus should be maximized to guarantee a fixed profit to the utility company; usually this fixed profit is set to zero.

A typical electricity generation cost vs. generated power is illustrated in FIG. 14. The curves can usually be adequately approximated using piece-wise linear, quadratic, or cubic functions. The pricing for the electricity from the generation side can be a function of amount of power generation or the amount of load.

For simplicity of design, a quadratic function as given in (9) is assumed between power generated and the cost of power:

C_{g}(P_{g})=a+bP_{g}+cP_{g}² (9)

where a, b and c are constants and P_{g} is the amount of power generated. Assume that the cost of electricity distribution is also included in the above relation. Using (9), the power generation cost during different hours of a day can be expressed as:

C_{g,i}(P_{g,i})=a+bP_{g,i}+cP_{g,i}²; i=1, . . . 24 (10)

Hence the total power generation cost is:

$$a . {C}_{g} ( {P}_{g , i} ) = {\sum }_{i = 1}^{24} ( a + {bP}_{g , i} + {cP}_{g , i}^{2} ) \qquad ( 11 )$$

If βᵢ is the electricity selling pricing to the customer during period i and P_{L,i} is the total power delivered to the consumers, the total electricity cost paid by the consumers in a day is given by:

$${C}_{L} ( {P}_{L , i} ) = {\sum }_{i = 1}^{24} {β}_{i} {P}_{L , i} \qquad ( 12 )$$

Consider that the whole day is divided into peak, normal and off-peak periods and the consumers are charged at different rates during these different periods of time. The cost paid by the consumer can be represented as β̅ⱼ∀j=1, 2, 3 where j=1, . . . , 3 corresponds to the peak, normal and off-peak period, respectively. Consumers can make a choice between consuming power now or shifting the appliance operation time to a different period of the day when electricity will be presumably cheaper. If the electricity price changes from β̅ⱼ to β̅ⱼ(1+Δ β̅ⱼ), then the power demand for electricity will change from Pᵢ to Pᵢ(1+ΔPᵢ), where ΔPᵢ is the percentage change in power consumption. Hence the total generation cost is given by:

$$a . {C}_{g} ( {P}_{gi} ) = {\sum }_{i = 1}^{24} a + {bP}_{i} ( 1 + Δ {P}_{i} ) + {c ( {P}_{i} ( 1 + Δ {P}_{i} ) )}^{2} \qquad ( 13 )$$

Let εᵢᵢ and εᵢⱼ represents self-elasticity and substitution elasticity, respectively. The percentage change in power consumption is given by:

$$i . Δ {P}_{i} = {\sum }_{j = 1}^{3} {ɛ}_{ij} Δ {\overline{β}}_{j} \qquad ( 14 )$$

If an increase in price does not modify the appliance operating schedule without a reduction in energy demand over a 24-hour scheduling period, the following relation holds between the elements of each column of the elasticity matrix:

$$i . {\sum }_{i = 1}^{24} {ɛ}_{ij} = 0 ∀ j \qquad ( 15 )$$

On the other hand, if the consumer reduces its demand, this relation becomes:

$$i . {\sum }_{i = 1}^{24} {ɛ}_{ij} < 0 ∀ j \qquad ( 16 )$$

By using the above relations, the total cost to the consumer can be written as:

$$1. {C}_{g} = {\sum }_{i = 1}^{24} {\sum }_{j = 1}^{3} \{ a + {bP}_{i} ( 1 + {ɛ}_{ij} Δ {\overline{β}}_{j} ) + {c ( P ( 1 + {ɛ}_{ij} Δ {\overline{β}}_{j} ) )}^{2} \} \qquad ( 17 )$$

Similarly, the power generation cost can be written as

$${C}_{c} = {\sum }_{i = 1}^{24} {β}_{i} ( 1 + Δ {β}_{i} ) {P}_{i} ( 1 + {\sum }_{j = 1}^{3} {ɛ}_{ij} Δ {\overline{β}}_{j} ) \qquad ( 18 )$$

Now consider the utility's pricing problem for the society's welfare maximization. The basic idea of this pricing method is that the electricity price of the generation side depends on the basis of a certain electricity consumption or power load, and the electricity demand of the demand side is closely relevant to the price. The pricing is relevant to the government, the utility company and the consumer. Hence the electric power system must be considered as public utility and the electricity should be priced using the Ramsey pricing rule. Based on the Ramsey pricing rule, the problem faced by the utility company is to maximize the consumer surplus and guarantee a fixed amount of profit to the utility company. This pricing rule is used for regulating the price for a multi-product monopolist. If the profit to the utility company is fixed to zero, then the cost of power generation (C_{g}) equals the cost paid by the consumer (C_{c}). Hence one obtains the following equality:

$$\begin{matrix}1. {\sum }_{i = 1}^{24} a + {bP}_{i} ( 1 + Δ {P}_{i} ) + {c ( {P}_{i} ( 1 + Δ {P}_{i} ) )}^{2} = {\sum }_{i = 1}^{24} {β}_{i} ( 1 + {Δβ}_{i} ) {P}_{i} ( 1 + Δ {P}_{i} ) & ( 19 ) \\ B . {\sum }_{i = 1}^{24} a + {bP}_{i} ( 1 + {\sum }_{j = 1}^{3} {ɛ}_{ij} Δ {\overline{β}}_{j} ) + {c ( P ( 1 + {\sum }_{j = 1}^{3} {ɛ}_{ij} Δ {\overline{β}}_{j} ) )}^{2} = {\sum }_{i = 1}^{24} β ( 1 + {Δβ}_{i} ) {P}_{i} ( 1 + {\sum }_{j = 1}^{3} {ɛ}_{ij} Δ {\overline{β}}_{j} ) & ( 20 )\end{matrix}$$

There are few set of constraints which the utility faces on maximum power generation. During the different hours of the day, if the maximum power availability is Pᵢ^{max}; i=1, . . . , 24 then the following constraint should be satisfied:

a. Pᵢ(1+ΔPᵢ)<Pᵢ^{max}; i=1, . . . ,24 (21)

Using conditions (18) and (19), the pricing problem can be formulated for maximizing the consumer surplus. The problem can be easily solved if the equality condition in (18) is converted to some inequality. The term on the left hand side of the inequality is the power generation cost and the right hand side of the inequality is the cost paid by the consumer. If the consumer surplus needs to be maximized, then the cost of electricity should be kept as low as possible. At the same time, the total revenue from the consumer should be greater than or equal to power generation cost. Hence the equality condition is changed to inequality as shown in (22).

$${\sum }_{i = 1}^{24} a + {bP}_{i} ( 1 + {\sum }_{j = 1}^{3} {ɛ}_{ij} Δ {\overline{β}}_{j} ) + {c ( P ( 1 + {\sum }_{j = 1}^{3} {ɛ}_{ij} Δ {\overline{β}}_{j} ) )}^{2} < {\sum }_{i = 1}^{24} {β}_{i} ( 1 + {Δβ}_{i} ) {P}_{i} ( 1 + {\sum }_{j = 1}^{3} {ɛ}_{ij} Δ {\overline{β}}_{j} ) \qquad ( 22 )$$

The objective of the problem is to maximize the consumer surplus. This can be written as

$$max {\sum }_{i = 1}^{24} {P}_{i} ( Δ {P}_{i} ) .$$

Using the above inequalities (21) and (22), the pricing problem can be formulated as the following optimization problem:

$$\begin{matrix} a . {max}_{Δ β} {\sum }_{i = 1}^{24} {\sum }_{j = 1}^{3} {P}_{i} {ɛ}_{ij} {Δβ}_{j} \\ b . subject to {\sum }_{i = 1}^{24} a + {bP}_{i} ( 1 + {\sum }_{j = 1}^{3} {ɛ}_{ij} Δ {\overline{β}}_{j} ) + {c ( P ( 1 + {\sum }_{j = 1}^{3} {ɛ}_{ij} Δ {\overline{β}}_{j} ) )}^{2} < {\sum }_{i = 1}^{24} {β}_{i} ( 1 + {Δβ}_{i} ) {P}_{i} ( 1 + {\sum }_{j = 1}^{3} {ɛ}_{ij} Δ {\overline{β}}_{j} ) & ( 23 ) \\ A . {P}_{i} ( 1 + Δ {P}_{i} ) < {P}_{i}^{max} ; i = 1 , … , 24 & ( 24 )\end{matrix}$$

The inequality in (23) is bilinear and hence it cannot be solved directly. If the value of Δ β̅ⱼ in the quadratic term is fixed, then it becomes a linear inequality and it can be solved directly. Then (23) and (24) can be solved by initially assuming a value of zero for the quadratic term and iteratively updating the value of the quadratic term.

The ANFIS model is used to predict the appliance switching ON time and its operating duration. To reduce the complexity in training, the input training data is divided into three sets viz., working day, weekend and holiday data. For each set of data two ANFIS models are built and the first model is used to predict the switching ON time and the second model is used to predict the operating duration of the appliance. For predicting the appliance ON time, the input variables considered for generating the model are the day of the week, season, room temperature and the time interval between the each operation of the appliance in the last two days in that data set. Similarly, for prediction of appliance operating duration, the inputs variables considered are day of the week, season, room temperature and the different operating duration of the appliance in the last two days in that data set.

For training and testing the ANFIS model, 5 weeks of data are generated. First 4 weeks data is used for training the ANFIS model and it is tested using the last 1 week data. Training and testing are carried out using the data generated for microwave oven, television, refrigerator, air conditioner and washing machine.

Certain appliances like washing machine will be operated once in two to four days. In that case, the appliance is assumed to follow weekly pattern. Instead of different models for working day, weekend and holiday data, only one set of model is used to predict the appliance usage. For washing machine, the inputs for modeling the appliance usage are the day of the week, season and the interval between each operation of the appliance in the past one week.

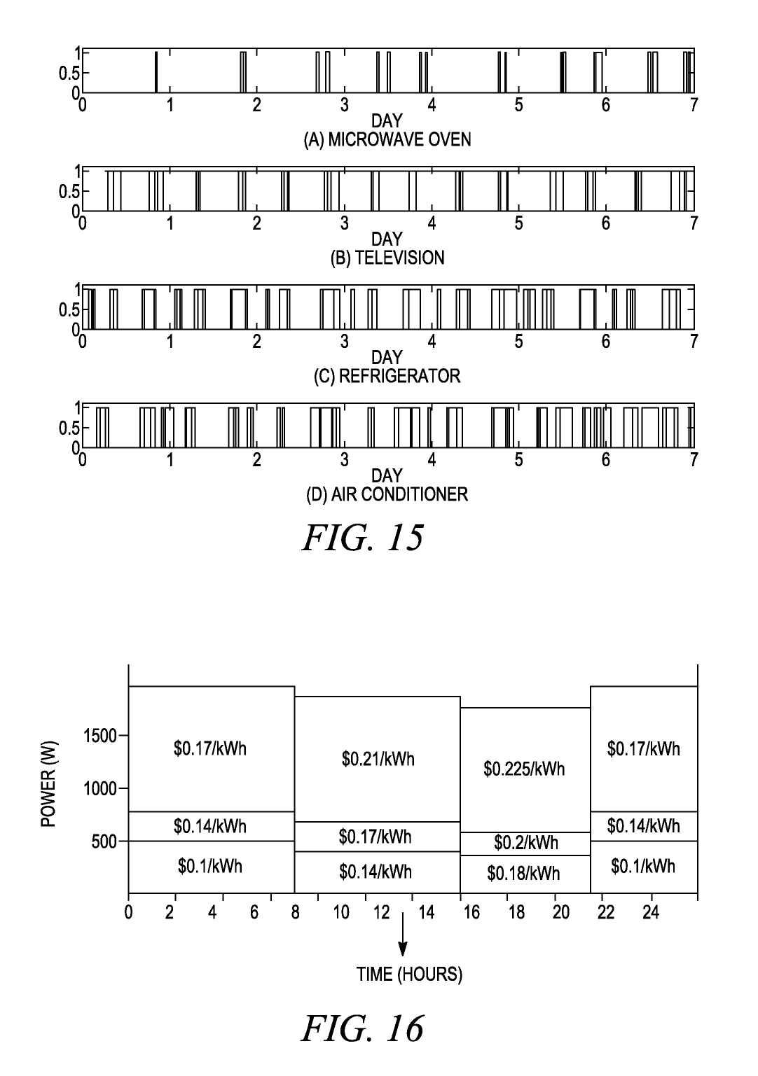

The prediction results for one week are shown in FIG. 15. Here ‘0’ and ‘1’ represents the appliance OFF state and ON state respectively. The starting day of the week is taken as Monday. In this prediction, Thursday is considered as a holiday. The results show that the ANFIS model can be used to predict the residential or commercial appliance usage pattern.

EXAMPLE: Let the power consumed by the must run appliances be taken as 0.1 kW during 12:00 AM-6:00 AM, 0.15 kW during 6:00 AM-9:00 AM, 0.175 kW during 9:00 AM-9:00 PM and 0.125 kW during 9:00 PM-12:00 PM. The time between 07:30 PM-07:00 AM, 07:00 AM-02:00 PM and 02:00 PM-07:30 PM is considered as peak, normal and off peak periods, respectively. The power availability and the cost per kWh during the off-peak period is considered to be P_{yz}={0.5, 0.25, 2.5} (kW), c_{yz}={0.1, 0.14, 0.17} ($/kWh), zε{a, b, c}. Similarly the power and cost during peak period is taken as P_{yz}={0.4, 0.2, 2.5} (kW), c_{yz}={0.18, 0.2, 0.225} ($/kWh), zε{a, b, c}. For normal period these values are P_{yz}={0.45, 0.25, 2.5} (kW), c_{yz}={0.14, 0.17, 0.21} ($/kWh), zε{a, b, c}. The graphical representation of the cost of electricity and the power availability during different period of the day is shown in FIG. 16.

Assume that we want to schedule the dishwasher, washing machine and cloth dryer. The lower and upper bound of the operating time is considered as 08:30 AM-11:00 AM for the washing machine and 09:00 AM-12:00 PM the cloth dryer. The dishwasher needs to be scheduled twice: between 08:00 AM-11:30 AM and between 7:00 PM-10:00 PM.

The branch-and-bound algorithm discussed in above is applied to the above scheduling problem. The optimal time of operation for the appliances as given by the algorithm is 08:00 AM for the dishwasher, 09:08 AM for the washing machine, 10:30 AM for the clothes dryer and 07:45 PM for the second operation of the dishwasher.

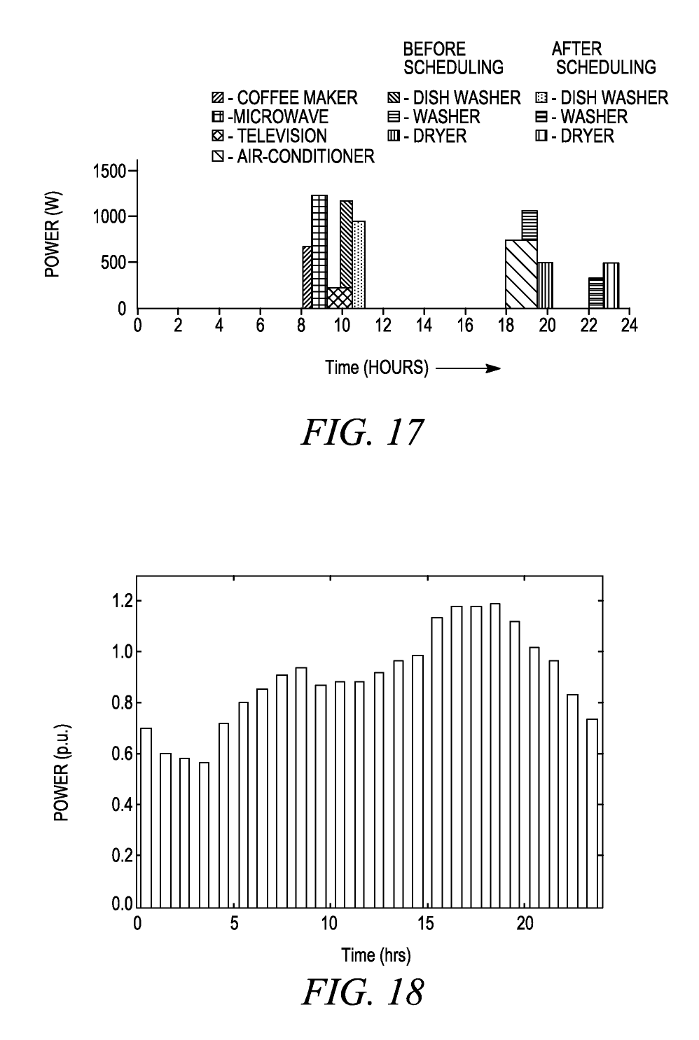

As another example, consider the case when a user has four appliances which must be turned on at a certain time and three appliances that have flexible starting times. Suppose the user decides to start these appliances as shown in FIG. 17. Using the scheduling algorithm with a typical pricing profile, the scheduler provides an alternative set of times, also shown in FIG. 17. The pricing differences are shown in Table 1.

TABLE 1
Price Differences With and Without Scheduling

| | Cost($)-before | Cost($)-after |
|---|---|---|
| Appliance | scheduling | scheduling |
| Dishwasher | 0.08 | 0.075 |
| Washer | 0.044 | 0.02 |
| Dryer | 0.063 | 0.045 |

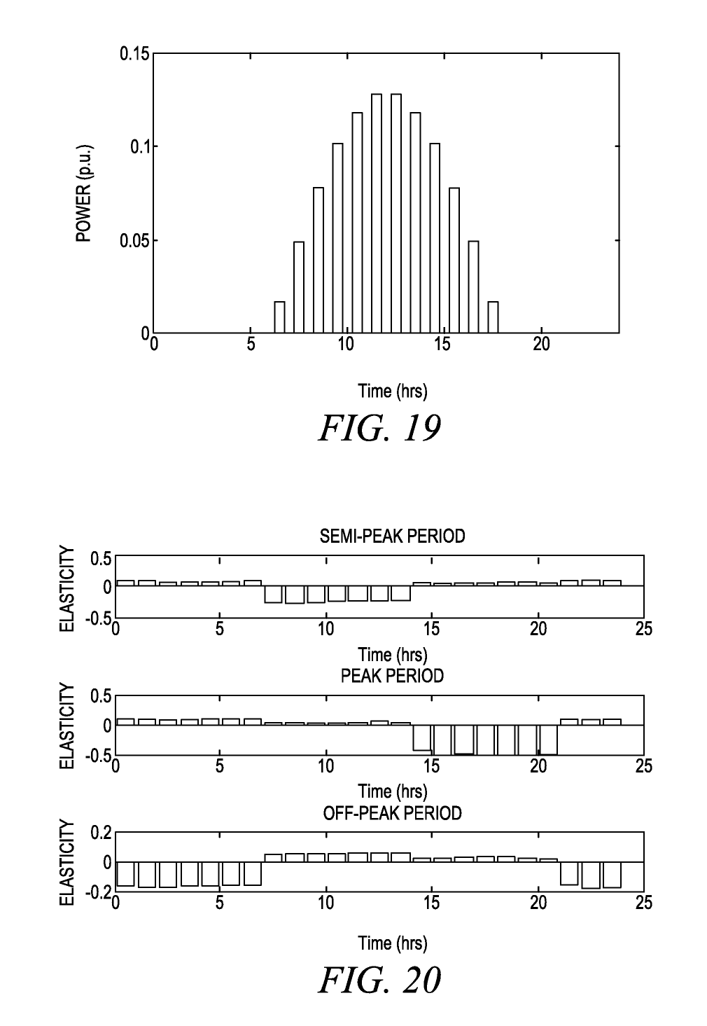

In order to show the effect of demand response on the load curve of the power distribution system, the power consumption profile, shown in FIG. 18, is considered. In this figure, the power is normalized with respect to the maximum power deliver capacity of the utility company. The total solar power availability during the day is taken as shown in FIG. 19. The times between 7 AM to 2 PM, 2 PM to 9 PM and 9 PM to 7 AM are taken as semi-peak, peak and off-peak periods, respectively. The initial prices (i.e., the prices if elasticity was not considered with a limited power generation capacity and without considering the demand response) assumed in this simulation during the peak, semi-peak and off peak are listed in Table 2.

TABLE 2
Power availability and the prices during
different periods of the day (Case (i)).

| | Semi-peak | Peak | Off-peak |
|---|---|---|---|
| | period | period | period |
| Available power (p. u.) | 1.0 | 1.0 | 1.0 |
| Initial price ($/kWh) | 0.20 | 0.24 | 0.15 |
| Calculated price ($/kWh) | 0.1756 | 0.3016 | 0.1364 |

The constants associated with the power generation cost and the transmission cost is assumed as a=0, b=0.13 and c=0.004 and the relation between these two is given by:

$$a . {C}_{g} ( {P}_{g , i} ) = {\sum }_{i = 1}^{24} ( 0.13 {P}_{g , i} + 0.004 {P}_{g , i}^{2} )$$

A household's power consumption and associated response to price variation vary depending upon the set of appliances a consumer owns; therefore it is natural to expect the factors influencing electricity demand to differ between different households. For example, a household that uses central air conditioning for most of the summer might be willing to alter its thermostat setting in response to a small change in the price of electricity, which can yield a large change in its electricity consumption. In contrast, a small household that uses electricity to operate only a refrigerator and a few lights might exhibit little or no demand response even to large price changes. This suggests that both a household's electricity consumption and its price sensitivity may depend delicately on the specific types of appliances it holds. Studies on price elasticity show that the air condition ownership had a very significant influence on demand response, and the load reductions are more than twice for households with air conditioning than for those without. Certain cost and energy conscious consumer may react to the high price and reduce the energy consumption by switching off certain appliances when it is not necessary or reducing the lighting loads. Farugui and George estimate substitution elasticities for different periods of the day and observed that the load reduction in peak period is between ten to fifteen percent and the increase in load is less than four percent for the off peak period. The price elasticities during different period of the day are considered and are shown in FIG. 20.

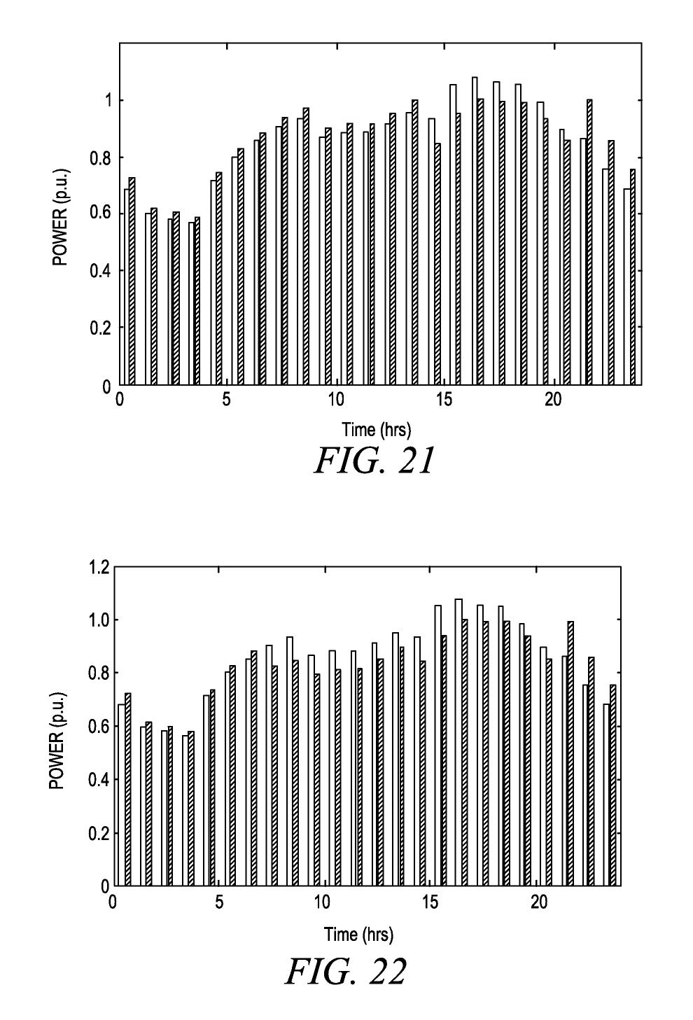

The optimization problem is solved using the LMI toolbox available in MATLAB® and the results are presented in Table 2 and FIG. 21. The profit to the utility company is assumed as zero. The calculated price is increased from the reference price during the peak period, since the required power during the peak period is greater than the supplying capacity of the utility company. By increasing the price during this period, the demand is adjusted to match the supply capacity.

Likewise, the demand during the off peak and the semi peak periods are less than the available capacity and the price during this period is reduced slightly so that the consumer will consume more power during this period and get more benefit. The profit gained by selling the electricity at high price during the peak period is used to give incentives to the consumers for the power consumption in off peak and semi peak period.

Consider another case where the power availability is limited to 0.9 p.u., during the semi peak period. The parameters considered in this simulation are given in Table 3. The power requirement in this case is greater than the supply capacity during the semi peak and the peak period. The results obtained in this case are shown in Table 3 and FIG. 22. The costs during the semi peak and the peak periods are increased to adjust the demand. The profits gained during this semi peak period and the peak periods are used to give incentive during the off peak period and the cost of electricity in this case is lower than that of case (i).

TABLE 3
Power availability and the price during different
periods of the day (Case (ii)).

| | Semi-peak | Peak | Off-peak |
|---|---|---|---|
| | period | period | period |
| Available power | 1.0 | 1.0 | 1.0 |
| (p. u.) | | | |
| Initial | 0.19 | 0.24 | 0.20 |
| price ($/kWh) | | | |
| Calculated | 0.2801 | 0.3301 | 0.1757 |
| rice ($/kWh) | | | |

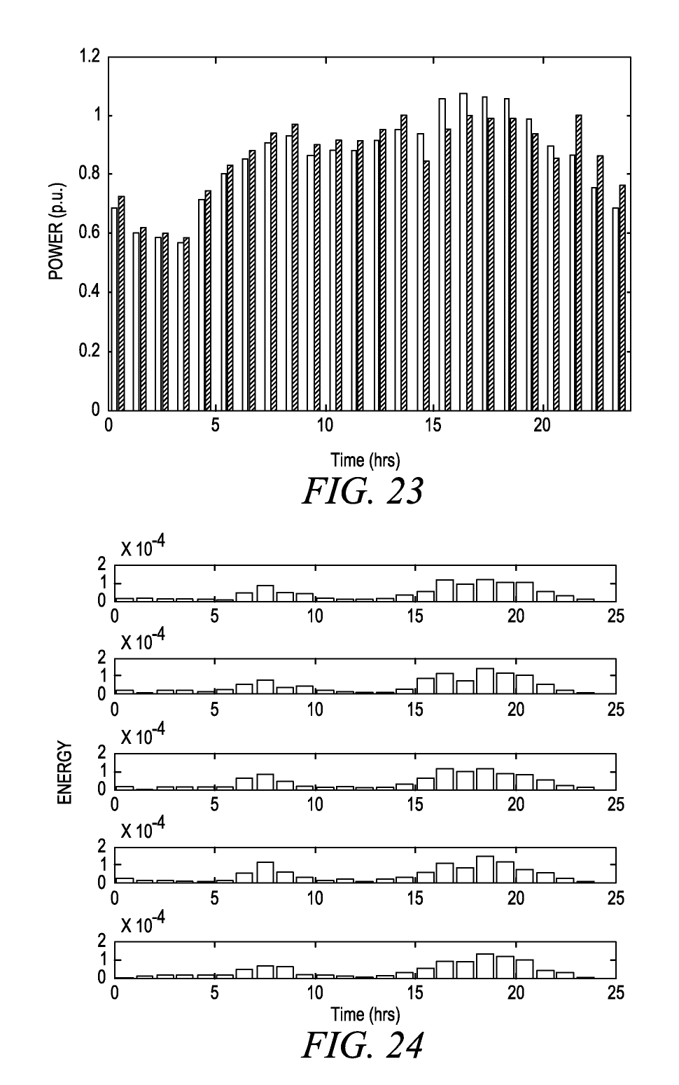

Next, consider the case with some amount of profit to the utility company. A profit amount equal to two percent of the total generation cost is assumed and the other parameters are assumed to be the same as in case (i). The problem is solved and the result obtained in this case is shown in Table 4 and FIG. 23. Since some amount of profit is included in the problem, the electricity cost is slightly higher than that of case (i).

TABLE 4
Power availability and the price during different
periods of the day (Case (iii)).

| | Semi-peak | Peak | Off-peak |
|---|---|---|---|
| | period | period | period |
| Available power | 1.0 | 1.0 | 1.0 |
| (p.u.) | | | |
| Initial price | 0.19 | 0.24 | 0.20 |
| ($/kWh) | | | |
| Calculated price | 0.1755 | 0.3159 | 0.1363 |
| ($/kWh) | | | |

Finally consider the electricity consumption pattern as shown in 24 when it is desired to estimate the effect of change in price. In this figure, the energy is normalized with respect to the maximum capacity of the utility company. Assume that the first two consumers are not responding to the change in price, the third consumer response is half when considering the overall elasticities and the last consumer response is the same as the elasticities given in FIG. 24.

In this case, the power consumption before and after the demand response is [15.4777 15.2003 14.6859 15.4891 14.3645] and [15.5551 15.2763 15.0837 16.2483 15.1047], respectively. The cost paid by the consumers before and after the demand response is [3.1146 3.0218 2.9168 3.1250 2.8746] and [2.4929 2.3521 2.3668 2.6373 2.3400], respectively. The total power consumed by all the consumers is increased after the demand response and at the same time the total cost paid by them is reduced. This shows that the demand response is effective in maximizing the overall benefit for the consumers

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. All documents referred to herein are hereby incorporated by reference for any purpose. However, if any such document conflicts with the present application, the present application controls. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of managing a residential or commercial energy system, comprising:
predicting power consumption of a building;
scheduling the powering of one or more appliances, sufficient to optimize a consumer's energy usage;
collecting usage profiles and demand; and
re-calculating the predicting of power consumption of a building.

2. The method of claim 1, wherein predicting comprises analyzing one or more of consumer's past energy choices, calendar information, temperature, environmental factors and energy supply from renewable energy sources.

3. The method of claim 1, further comprising after predicting, calculating the probability of a specific appliance to be powered in a near future time frame.

4. The method of claim 1, wherein predicting comprises estimating the impact of incentives generated by the utility.

5. The method of claim 1, wherein scheduling comprises displaying control options to a consumer for modification of the suggested schedule.

6. The method of claim 1, wherein scheduling comprises avoiding peak demand periods.

7. The method of claim 1, wherein scheduling comprises reducing consumption when the building is vacated.

8. The method of claim 1, wherein collecting comprising reporting to a utility company.

9. The method of claim 1, wherein re-calculating comprises re-calculating at the building, re-calculating at the utility company or both.

10. A residential or commercial energy management system, comprising:
a predictor, for estimating power consumption at a building;
one or more master controllers;
one or more appliance network nodes, forming a self-organizing network; and
an aggregator, accumulating demand in a region for time of use pricing.

11. The residential or commercial energy management system of claim 10, wherein the one or more master controllers includes a graphical user interface (GUI).

12. The residential or commercial energy management system of claim 10, wherein the one or more master controllers schedules the powering of the one or more appliances.

13. The residential or commercial energy management system of claim 10, wherein the one or more master controllers captures the consumer's preferences to be used for prediction of future demand.

14. The residential or commercial energy management system of claim 10, wherein the aggregator which collects usage profiles and demand for energy in the future from the one or more master controllers.

15. The residential or commercial energy management system of claim 10, wherein the one or more master controllers are located at the building, at the utility company or both.
